(19) United States
(12) Patent Application Publication
(10) Pub. No.: US 2024/0353714 A1
(43) Pub. Date: Oct. 24, 2024

(54) POLYIMIDE AND DISPLAY PANEL

(71) Applicant: Guangzhou China Star Optoelectronics Semiconductor Display Technology Co., LTd., Guangzhou (CN)

(72) Inventor: Yang LIU, Guangzhou (CN)

(73) Assignee: Guangzhou China Star Optoelectronics Semiconductor Display Technology Co., LTd., Guangzhou (CN)

(21) Appl. No.: 18/523,742

(22) Filed: Nov. 29, 2023

(30) Foreign Application Priority Data
Apr. 20, 2023 (CN) 202310429302.X

(51) Int. Cl. G02F 1/1337; C08G 73/10; C09K 19/54

(52) U.S. Cl. CPC G02F 1/133723; C08G 73/1046; C09K 19/544

(57) ABSTRACT

Disclosed are a polyimide and a display panel. A main chain of the polyimide includes at least one graft group, and the graft group is bonded with a first side-chain group and a second side-chain group. The graft group is selected from a phenyl group or a heterophenyl group, and the first side-chain group and the second side-chain group are bonded to the graft group in a meta-substitution manner. The first side-chain group is represented by a formula (1), and the second side-chain group is represented by a formula (2).

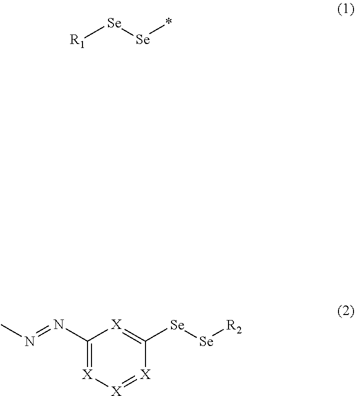

### CROSS-REFERENCE TO RELATED APPLICATION

This application claims priority to Chinese Patent Application No. 202310429302.X, filed on Apr. 20, 2023, the disclosure of which is incorporated herein by reference in its entirety.

### TECHNICAL FIELD

The present disclosure relates to the field of display technologies, and in particular, to polyimides and display panels.

### BACKGROUND

Liquid crystal alignment layers, as a key unit in thin-film transistor liquid crystal display (TFT-LCD), are organic polymer films with a thickness of about 100 nanometers (nm). The liquid crystal alignment layer plays a role in maintaining orderly arrangement of upper liquid crystal molecules. The alignment ability of the liquid crystal alignment layer is the basis of controllable direction of liquid crystal molecules, which will ultimately determine the performance parameters (such as image sticking and reliable ability) of TFT-LCD display devices.

In traditional methods, the liquid crystal alignment layer is generally rubbed to generate orderly arranged channels on a surface of the layer, so as to achieve alignment. However, the method has the disadvantage of generating large dust, which can cause particle pollution and electrostatic damage to the layer, thereby limiting further breakthroughs in the performance of the TFT-LCD display devices. In recent years, a photo-alignment method uses linear polarized light to induce the photochemical reaction of polymers on the surface of the layer to produce anisotropic distribution on the surface of the liquid crystal alignment layer, which has the advantages of no need for contact, and small variations in precision and batch size. However, there are still some problems to be solved in this new technology, such as small anchoring energy and poor stability. Overcoming the above problems would be beneficial to improve the performance of the TFT-LCD display devices.

### SUMMARY

The present disclosure provides a polyimide and a display panel, and the polyimide can solve the problem of poor photo-alignment stability.

In order to solve the above problems, in a first aspect, the present disclosure provides a polyimide, a main chain of the polyimide includes at least one graft group, and the graft group is bonded with a first side-chain group represented by the following formula (1) and a second side-chain group represented by the following formula (2);

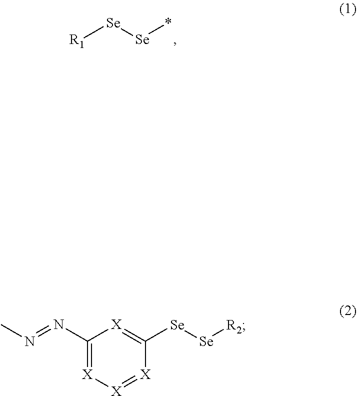

wherein R₁ and R₂ are independently selected from the group consisting of an alkyl group, an aryl group, and a heteroaryl group, X is at each occurrence independently selected from nitrogen (N) or a carbon Y group (CY), Y is selected from hydrogen or an alkyl group, and * represents a substitution site;
the graft group is selected from a phenyl group or a heterophenyl group, and the first side-chain group and the second side-chain group are bonded to the graft group in a meta-substitution manner.

In the polyimide provided by some embodiments of the present disclosure, the polyimide includes a plurality of first repeating units and a plurality of second repeating units, and the a plurality of second repeating units have the graft group.

In the polyimide provided by some embodiments of the present disclosure, a structure of the first repeating unit is represented by the following formula (3), and a structure of the second repeating unit is represented by the following formula (4) as follows:

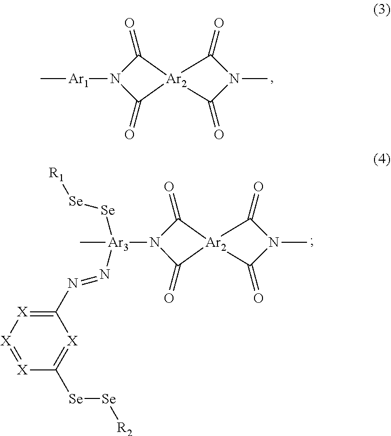

wherein Ar₁ to Ar₃ are independently selected from an aryl or a heteroaryl group having 6 to 30 ring atoms, and Ar₃ has the graft group, and the first side-chain group and the second side-chain group are bonded to the one graft group.

In the polyimide provided by some embodiments of the present disclosure, a structure of the polyimide is represented by the following formula (5):

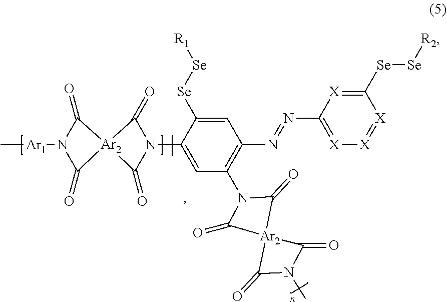

wherein m and n are independently selected from positive integers.

In the polyimide provided by some embodiments of the present disclosure, R₁ and R₂ are independently selected from the group consisting of a methyl group, an ethyl group, a propyl group, a butyl group, a pentyl group, a hexyl group, the phenyl group, a biphenyl group, a naphthyl group, and a pyridyl group.

In the polyimide provided by some embodiments of the present disclosure, a structure of the second side-chain group is shown in the following formula:

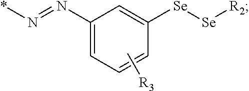

wherein R₃ is selected from a linear alkyl group or a branched alkyl group.

In the polyimide provided by some embodiments of the present disclosure, Ar₁ is selected from the group consisting of:

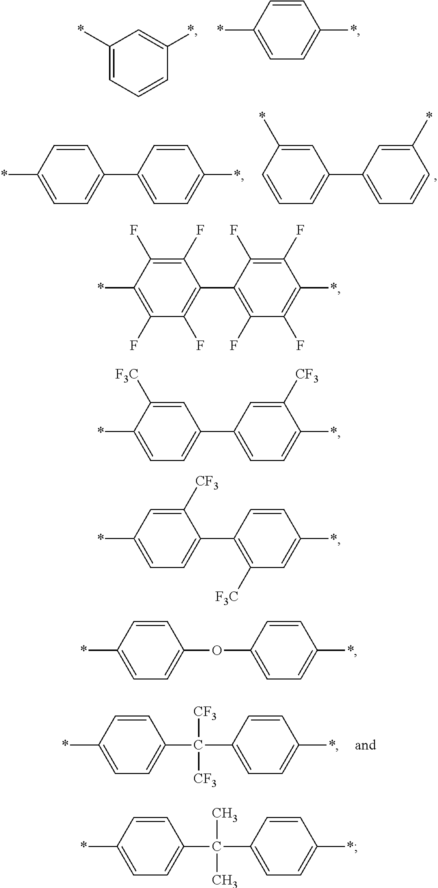

and/or
Ar₂ is selected from the group consisting of

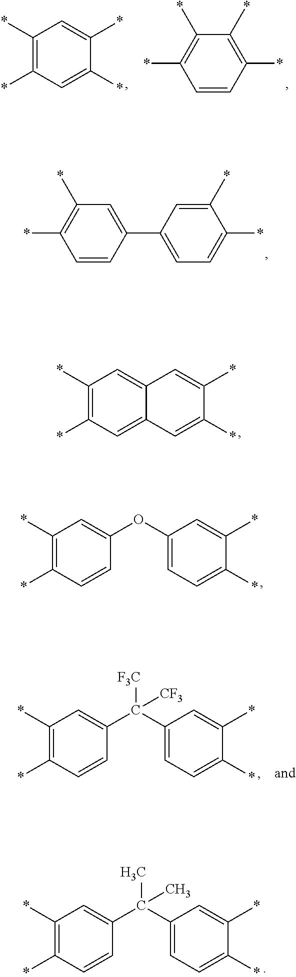

In the polyimide provided by some embodiments of the present disclosure, a ratio of a number of the plurality of second repeating units to a total number of the plurality of first repeating units and the plurality of second repeating units is less than or equal to 30%.

In the polyimide provided by some embodiments of the present disclosure, a relative molecular mass of the polyimide is in a range of 1,000-10,000.

In a second aspect, the present disclosure provides a display panel, which includes a first substrate and a second substrate disposed opposite to each other, and a liquid crystal layer sandwiched between the first substrate and the second substrate. An alignment layer is arranged on at least one of a side of the first substrate close to the liquid crystal layer and a side of the second substrate close to the liquid crystal layer; and the alignment layer is made of the polyimide.

### BRIEF DESCRIPTION OF THE DRAWINGS

In order to describe technical solutions in embodiments of the present disclosure clearly, the drawings needed in the description of the embodiments will be briefly introduced below. Apparently, the drawings in the following description are only some embodiments of the present disclosure. For those skilled in the art, other drawings can be obtained according to these drawings without creative effort.

FIG. 1 illustrates a schematic structural cross-sectional view of a display panel according to some embodiments of the present disclosure.

### DETAILED DESCRIPTION

Technical solutions in embodiments of the present disclosure will be clearly and fully described below with reference to the attached drawings. Apparently, the illustrated embodiments are only some of the embodiments of the present disclosure and not all of them. Based on the embodiments in the present disclosure, all other embodiments obtained by those skilled in the art without creative effort belong to the scope of the present disclosure.

In the description of the present disclosure, it is to be understood that the terms, such as “center”, “longitudinal”, “lateral”, “length”, “width”, “thickness”, “up”, “down”, “front”, “rear”, “left”, “right”, “vertical”, “horizontal”, “top”, “bottom”, “inner”, “outer”, indicate orientation or positional relationships based on those shown in the drawings, and are intended only to facilitate the description of the present disclosure and to simplify the description, and are not intended to indicate or imply that the devices or elements referred to must have a particular orientation and be constructed and operated in a particular manner, and therefore these terms are not to be construed as a limitation of the present disclosure. In addition, the terms “first” and “second” are only used for descriptive purposes, and cannot be construed as indicating or implying relative importance or as implying the number of technical features indicated. Thus, the features defined as “first” and “second” may explicitly or implicitly include one or more of the features. In the description of the present disclosure, “a plurality of” means two or more, unless otherwise specifically defined.

In the present disclosure, the term “exemplary” is used to mean “used as an example, illustration, or description”. Any embodiment described as “exemplary” in the present disclosure is not necessarily to be construed as more preferred or advantageous than other embodiments. In order to enable those skilled in the art to make and use the present disclosure, the following description is given. In the following description, details are set forth for the purpose of explanation. It is to be understood that those skilled in the art will recognize that the present disclosure may be practiced without these specific details. In other instances, well-known structures and processes are not set forth in detail to avoid obscuring the description of the present disclosure with unnecessary details. Therefore, the present disclosure is not intended to be limited to the illustrated embodiments, but is consistent with the broadest scope consistent with the principles and features disclosed herein.

At present, the following three photo-alignment methods are usually used in the field to align a liquid crystal alignment layer (also referred to as a liquid crystal alignment film).

The first method is a decomposition type photo-alignment method. Specifically, linear polarized light with a wavelength of 254 nanometers (nm) is used to irradiate polyimide (PI) containing a four-membered ring unit. Due to a large strain of the four-membered ring, the PI main chain polymer in a characteristic direction is decomposed into oligomers due to light irradiation, and then the oligomers are directionally distributed around the undecomposed polyimide. The principle is shown in the following chemical equation:

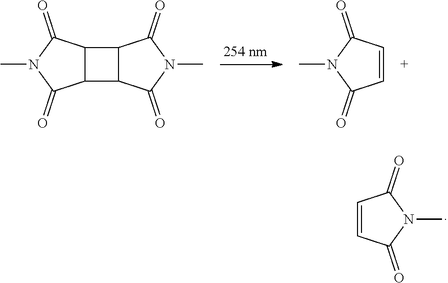

The second method is a polymerization type photo-alignment method. Specifically, linear polarized light with a wavelength of 313 nm is used to irradiate a polyimide film containing an olefin side chain, and the side chain in a characteristic direction may undergo 2+2 cycloaddition reaction, which results in an anisotropic arrangement in the film in a specific direction. The principle is shown in the following chemical equation:

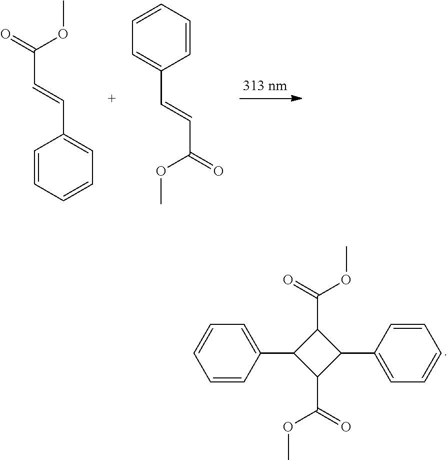 [SMILES: COC(=O)/C=C/c1ccccc1 ; COC(=O)/C=C/c1ccccc1 ; COC(=O)C1C(c2ccccc2)C(C(=O)OC)C1c1ccccc1]

The third method is a heterogeneous photo-alignment method. Specifically, linear polarized light with a wavelength of 365 nm is used to irradiate a polyimide film containing a diazo side chain, and the side chain in a characteristic direction may be transformed from a trans arrangement to a cis arrangement by light irradiation, thus aligning the polyimide film. The principle is shown in the following chemical equation:

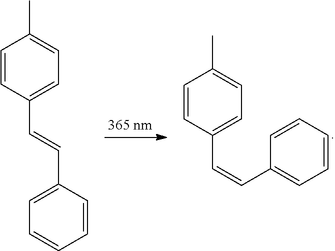

However, the above three photo-alignment methods have certain technical defects at present, which restrict the development of large-scale industrialization.

Firstly, in the decomposition type photo-alignment method, the four-membered ring serves as a characteristic functional group, which has a high ring strain and the risk of decomposition under the irradiation of light of non-254 nm wavelength. Usually, the anchoring force of polyimide prepared by this method is weaker than that by a rubbing method, and thus the matching degree to liquid crystal is smaller.

Secondly, in the polymerization type photo-alignment method, olefin serves as a characteristic functional group, and the strain of the four-membered ring generated after irradiation is large, and thus there is a large challenge for the photo-thermal stability of the PI film prepared by this method.

Thirdly, in the heterogeneous type photo-alignment method, the diazo functional group serves as a characteristic functional group, which is easier to react than the related characteristic functional groups in the first two methods, but its photo-alignment stability is the worst, since the thermodynamically stable conformation of the diazo functional group is a trans structure.

In order to solve the above technical problems, embodiments of the present disclosure provide a polyimide based on the above heterogeneous type photo-alignment method, which has a trans conformation with high stability, and thus has a high photo-alignment stability, as described in detail below.

An embodiment of the present disclosure provides a polyimide, and a main chain of the polyimide includes at least one graft group. The graft group is bonded with a first side-chain group represented by the following formula (1) and a second side-chain group represented by the formula (2);

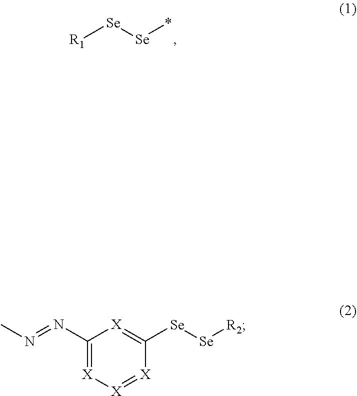

R₁ and R₂ are independently selected from the group consisting of an alkyl group, an aryl group, and a heteroaryl group, X is at each occurrence independently selected from nitrogen (N) or a carbon Y group (CY), Y is selected from hydrogen or an alkyl group, and * represents a substitution site.

The graft group is selected from a phenyl group or a heterophenyl group, and the first side-chain group and the second side-chain group are bonded to the graft group in a meta-substitution manner.

According to the embodiment of the present disclosure, the structure of the polyimide is designed by incorporating the first side-chain group and the second side-chain group with a specific structure, so that a stable cis structure can be formed under light irradiation. Taking phenyl as the graft group as an example, the principle is explained in combination with the following chemical equation:

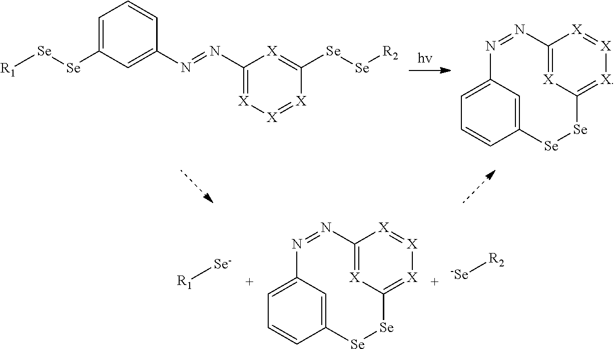

When light (usually linear polarized light with a wavelength of 365 nm) is used to irradiate the film formed by the polyimide at a specific angle, the diazo fragment in the second side-chain group is transformed from a trans structure to a cis structure, and simultaneously, the selenide fragment in the first side-chain group and the selenide fragment in the second side-chain group can also be cleaved under light irradiation and release selenium radicals. After the diazo fragment is transformed into the cis structure, the selenium radicals in the first side-chain group are closer to the selenium radicals in the second side-chain group and are easier to meet. Therefore, after completion of light irradiation, the selenium radicals in the first side-chain group and the selenium radicals in the second side-chain group are bonded to form a new selenide structure to close the cis structure of the diazo fragment, thereby improving the stability of the cis structure, and in turn enhancing the light irradiation stability of the polyimide and the anchoring force to liquid crystal molecules, and thus a better alignment effect can be obtained.

In the process of photo-alignment of the polyimide, its main chain has no bond breakage, which is conducive to maintain the strength of the polyimide, thus improving the anchoring energy. In addition, the selenide functional group and the diazo functional group in the polyimide are readily available commercially and more susceptible to photoresponse than a carbon-carbon double bond functional group, thereby facilitating the reduction of cost and increase of efficiency.

In view of the above, when the polyimide provided by the embodiment of the present disclosure is used for photo-alignment, the cis structure of the polyimide has high stability and no bond breakage occurs on the main chain of the polyimide, so that the light irradiation stability of the polyimide and the anchoring force to the liquid crystal molecules are enhanced, and a better alignment effect can be obtained. In addition, the raw materials of the polyimide are readily available commercially, making its preparation cost low and suitable for large-scale industrialization.

In some embodiments, the polyimide includes a plurality of first repeating units and a plurality of second repeating units. The second repeating unit has the graft group, and the first repeating unit is an imide unit. The second repeating unit is an imide unit bonded with the first side-chain group and the second side-chain group.

In some embodiments, the structure of the first repeating unit is represented by the following formula (3), and the structure of the second repeating unit is represented by the following formula (4):

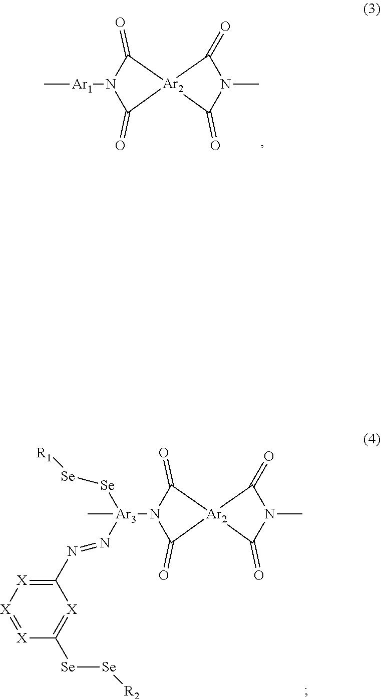

Ar₁ to Ar₃ are independently selected from an aryl or a heteroaryl group having 6 to 30 ring atoms, and Ar₃ has the graft group to which the first side-chain group and the second side-chain group are bonded.

In some embodiments, the structure of the polyimide is represented by the following formula (5):

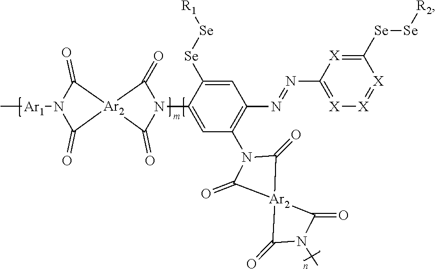

m and n are independently selected from positive integers.

In some embodiments, R₁ and R₂ are independently selected from the group consisting of a methyl group, an ethyl group, a propyl group, a butyl group, a pentyl group, a hexyl group, a phenyl group, a biphenyl group, a naphthyl group, and a pyridyl group.

In some embodiments, the structure of the second side-chain group is shown in the following formula:

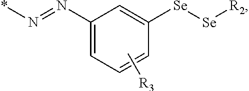

Y is selected from a linear alkyl group or a branched alkyl group, and the number of carbon atoms of the Y is not particularly limited, generally 1 to 20, which is determined according to specific process requirements. Y is beneficial to increase the solubility of the polyimide.

In some embodiments, the structure of the second side-chain group is shown in the following formula:

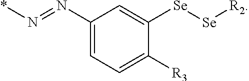

In some embodiments, Ar₁ is selected from the group consisting of:

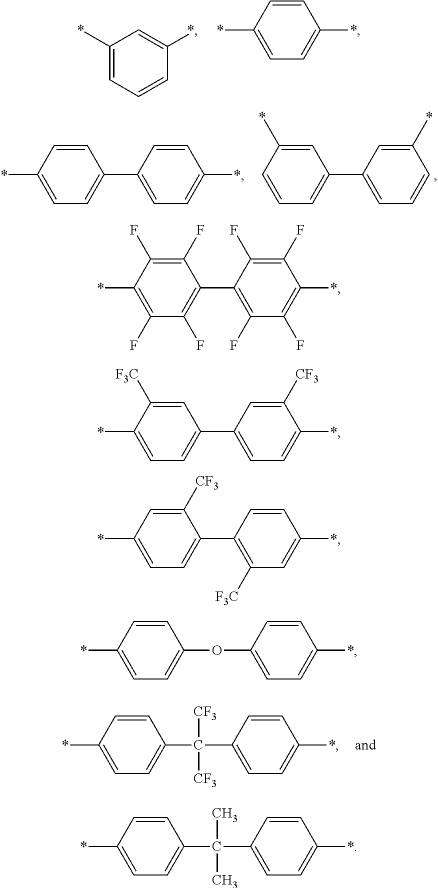

Ar₂ is selected from the group consisting of:

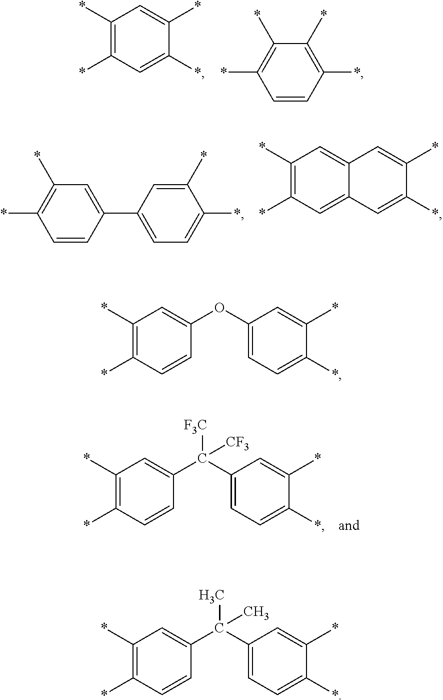

In some embodiments, the structure of the polyimide is represented by the formula as follows.

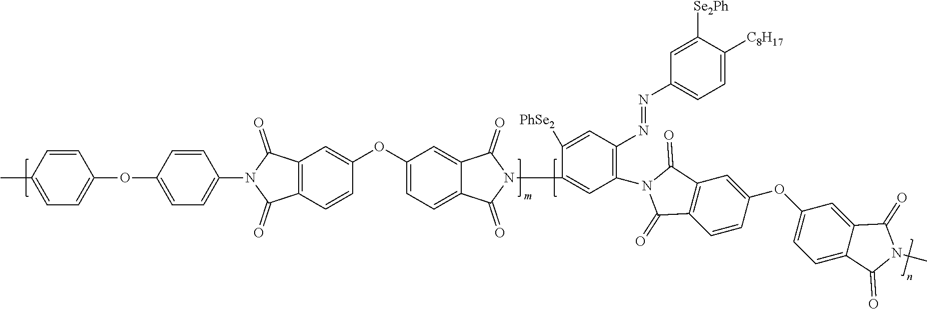

In some embodiments, a ratio of the number of the second repeating units to a total number of the first repeating units and the second repeating units is less than or equal to 30%, which is specifically selected within the above ranges according to actual process requirements.

In some embodiments, a relative molecular mass of the polyimide is in a range of 1,000-10,000, which is selected within the above ranges according to the actual process requirements.

An embodiment of the present disclosure provides a display panel, which includes a first substrate and a second substrate disposed opposite to each other, and a liquid crystal layer sandwiched between the first substrate and the second substrate. An alignment layer is arranged on a side of the first substrate close to the liquid crystal layer, or on a side of the second substrate close to the liquid crystal layer, or alignment layers are arranged on both a side of the first substrate close to the liquid crystal layer and a side of the second substrate close to the liquid crystal layer. The alignment layer is made of the polyimide provided in the above embodiments.

Specifically, one of the first substrate and the second substrate is an array substrate, and the other is a color film substrate. According to the actual alignment process, a side of the first substrate close to the liquid crystal layer or a side of the second substrate close to the liquid crystal layer is provided with an alignment layer, or a side of the first substrate close to the liquid crystal layer and a side of the second substrate close to the liquid crystal layer are provided with an alignment layer, respectively.

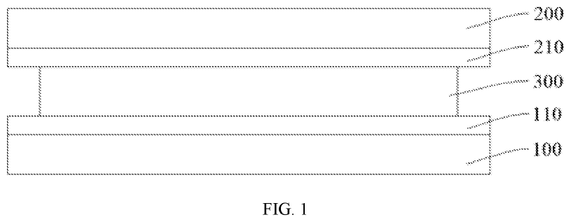

Illustratively, a display panel with alignment layers on both the first substrate and the second substrate is shown. Referring to FIG. 1, the display panel includes a first substrate 100 and a second substrate 200 disposed opposite to each other and a liquid crystal layer 300 sandwiched between the first substrate 100 and the second substrate 200. A first alignment layer 110 is arranged on a side of the first substrate 100 close to the liquid crystal layer 300, and a second alignment layer 210 is arranged on a side of the second substrate 200 close to the liquid crystal layer 300. The first alignment layer 110 and the second alignment layer 220 are made of the polyimide provided in the above embodiments.

In the display panel provided by the embodiments of the present disclosure, since the alignment layer is made of the polyimide provided by the above embodiments, and the polyimide has high light irradiation stability and strong anchoring force to liquid crystal molecules, the formed display panel has higher performance stability and reliability.

The present disclosure will be further described with specific examples as follows.

### Example 1

Steps of preparation of a first polyimide film are as follows.

(1) Raw materials ODA, ODPA and A1 are provided as follows:

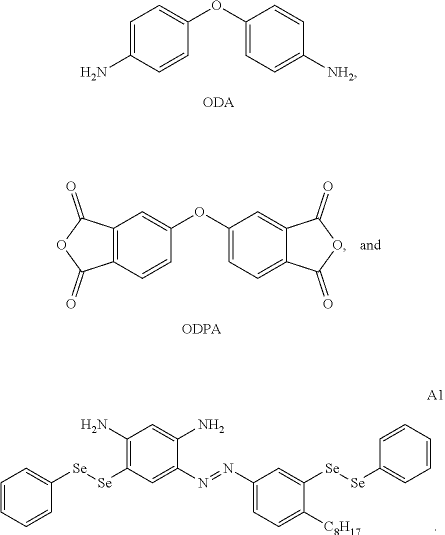

(2) ODA, the A1 and dimethylacetamide are added into a 100 milliliters (mL) three-neck round-bottomed flask equipped with mechanical stirring and nitrogen protection, and stirred to completely dissolve the A1. Then, the three-neck round-bottomed flask is placed in an ice-water bath and cooled to below 5° C. ODPA is added to the three-neck round-bottomed flask, and supplemented with the solvent dimethylacetamide to adjust a solid content of the system to 20%. Specifically, a molar ratio of added A1/ODA/ODPA is 0.3:0.7:1, and the reaction is continued with stirring for 10 hours (h) in nitrogen atmosphere to obtain a transparent and viscous solution containing polyamide acid B1, the structure of the polyamide acid B1 is shown in the formula as follows.

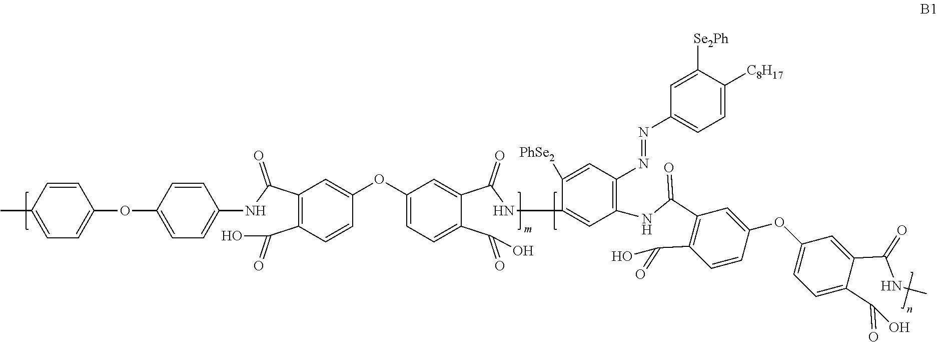

(3) A clean substrate is placed on a film coating machine, and coated with the solution containing polyamide acid B1 obtained in the step (2) to form a film. Then, the hot platform of the film coating machine is heated to 70-110° C. at 20° C./h for pre-baking of the film, and most of the solvent in the film is removed at room temperature to obtain a dry, complete, uniform and bubble-free film. Then, the film is placed in a muffle furnace, and the film containing polyimide P1 with a thickness of 100 nm is obtained by high temperature imidization according to a programmed temperature mode. The structure of polyimide P1 is shown in the formula as follows.

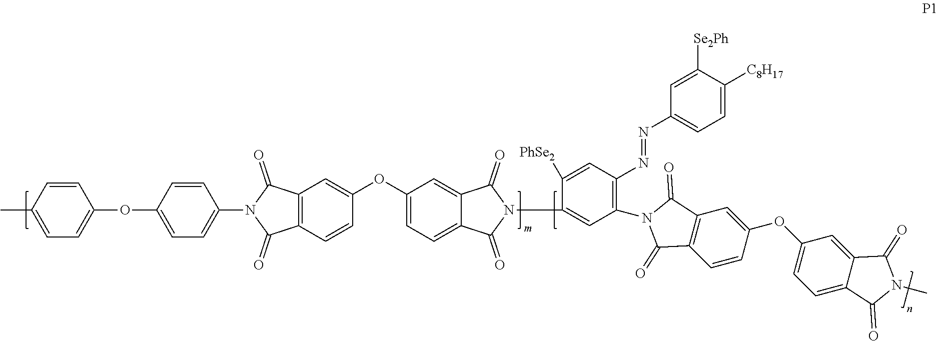

(4) The film containing polyimide P1 prepared in the step (3) is exposed to a linear polarized ultraviolet light source with a wavelength of 365 nm to obtain the first polyimide film.

### Example 2

Steps of preparation of a second polyimide film are as follows.

(1) Raw materials ODA, ODPA and A2 are provided as follows:

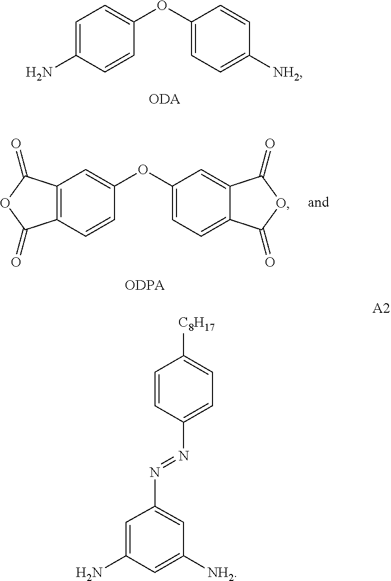

(2) ODA, the A2 and dimethylacetamide are added into a 100 mL three-neck round-bottomed flask equipped with mechanical stirring and nitrogen protection, and stirred to completely dissolve the A2. Then, the three-neck round-bottomed flask is placed in an ice-water bath and cooled to below 5° C. ODPA is added to the three-neck round-bottomed flask, and supplemented with the solvent dimethylacetamide to adjust the solid content of the system to 20%. Specifically, a molar ratio of A2/ODA/ODPA added is 0.3:0.7:1, and the reaction is continued with stirring for 10 h in nitrogen atmosphere to obtain a transparent and viscous solution containing polyamide acid B2. The structure of polyamide acid B2 is shown in the formula as follows.

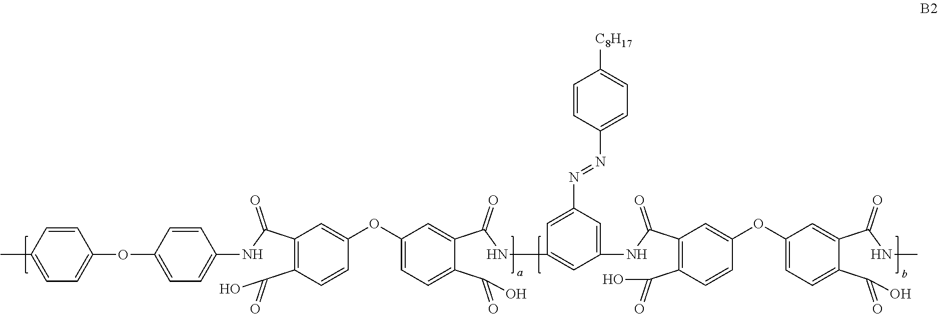

(3) A clean substrate is placed on a film coating machine, and coated with the solution containing polyamide acid B2 obtained in the step (2) to form a film. Then, the hot platform of the film coating machine is heated to 70-110° C. at 20° C./h for pre-baking of the film, and most of the solvent in the film is removed at room temperature to obtain a dry, complete, uniform and bubble-free film. Then the film is placed in a muffle furnace, and the film containing polyimide P2 with a thickness of 100 nm is obtained by high temperature imidization according to a programmed temperature mode. The structure of polyimide P2 is as follows.

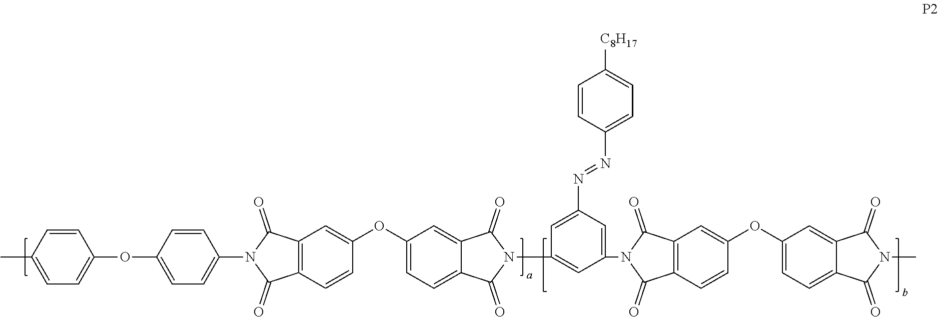

(4) The film containing polyimide P2 prepared in the step (3) is exposed to a linear polarized ultraviolet light source with a wavelength of 365 nm to obtain the second polyimide film.

### Example 3

Using time of flight secondary ion mass spectrometry (Tof-SIMS), the diazo group signal peaks of first polyimide film and second polyimide film prepared in the above examples are characterized under two heating conditions (T/S Open-substrate 83° C. and T/S Close-substrate 100° C.), and the test results are shown in the following Table 1.

TABLE 1

| | 83° C. | 100° C. |
|---|---|---|
| First polyimide film | 684.11 | 254.74 |
| Second polyimide film | 4.02 | 70.67 |

According to the above data, under different heating conditions, compared with the second polyimide film, the first polyimide film shows extremely high diazo signal peak, indicating that the selenide diazo structure generated by the exposure treatment of the polyimide A1 has a higher stability, and thus can be detected by stably stretching in the surface of the film.

### Example 4

According to the methods of the Examples 1 and 2, taking indium tin oxide (ITO) conductive glasses as substrates, the conductive glass coated with the first polyimide film and the conductive glass coated with the second polyimide film are prepared, and two conductive glasses coated with the first polyimide film are assembled in anti-parallel to form a first liquid crystal cell, and two conductive glasses coated with the second polyimide film are assembled in anti-parallel to form a second liquid crystal cell.

Firstly, the anchoring energy of liquid crystal molecules on the surface of the polyimide film is tested by torque balance method. Specifically, the liquid crystal cell is placed between orthogonal polarizers, and the optical signal reaching the detector is recorded by a digital oscilloscope. According to the change of the intensity of the optical signal, the torsion angle of liquid crystal molecules is calculated, and the anchoring energy is calculated.

Secondly, the checkerboard method is used to test the afterimage (also referred to as image sticking) after the liquid crystal cell working for 168 h and releasing for 1 h, and the just-noticeable difference (JND) value is taken as the measure of the afterimage.

The test results are summarized in Table 2 below.

TABLE 2

| | Anchoring energy (J/m²) | Afterimage (JND) |
|---|---|---|
| First liquid crystal cell | 3.1*10⁻⁶ | 3.2 |
| Second liquid crystal cell | 8.5*10⁻⁶ | <2.0 |

According to the above data, the anchoring energy of the second polyimide film in the second liquid crystal cell is 3.1*10⁻⁶ J/m², indicating that the second polyimide film has a certain alignment ability to liquid crystal molecules. After working for 168 h and releasing the afterimage for 1 h, the JND value of the afterimage is 3.2, which means that the working stability of the second liquid crystal cell is poor. The anchoring energy of the first polyimide film in the first liquid crystal cell is as high as 8.5*10⁻⁶ J/m², which is more than twice that of the second polyimide film, indicating that the anchoring effect on the liquid crystal molecules is significantly enhanced. In addition, after working for 168 h and releasing the afterimage for 1 h, the JND value of the afterimage is less than 2, which proves that the working stability of the first liquid crystal cell is significantly improved compared with that of the second liquid crystal cell.

In summary, according to the polyimide provided by the embodiment of the present disclosure, in the display panel prepared by using the polyimide as the material of the alignment layer, the anchoring effect of the alignment layer on liquid crystal molecules is enhanced, so that the working stability of the display panel is improved, and further, the display panel has better reliability.

The embodiments of the present disclosure provide the polyimide and the display panel, the main chain of the polyimide includes at least one graft group, and the graft group is bonded with the first side-chain group and the second side-chain group. The graft group is selected from phenyl or heterophenyl, and the first side-chain group and the second side-chain group are bonded to the graft group in a meta-substitution manner. When the polyimide is used for photo-alignment, the diazo fragment in the second side-chain group is transformed from a trans structure to a cis structure, and simultaneously, the selenide fragment in the first side-chain group and the selenide fragment in the second side-chain group can also be cleaved under light irradiation and release selenium radicals. After the diazo fragment is transformed into the cis structure, the selenium radicals in the first side-chain group are closer to the selenium radicals in the second side-chain group and are easier to meet. Therefore, after the end of light irradiation, the selenium radicals in the first side-chain group and the selenium radicals in the second side-chain group are bonded to form a new selenide structure, the cis structure of the diazo fragment is closed, the stability of the cis structure is greatly improved, so that the light irradiation stability of the polyimide and the anchoring force to liquid crystal molecules are significantly enhanced, and a better alignment effect can be obtained. Moreover, the raw materials of the polyimide are readily available in the market, so that the preparation cost of the polyimide is low, and the polyimide is suitable for large-scale industrialization.

The polyimide and the display panel provided by the embodiments of the present disclosure are described in detail above. The principle and implementation of the present disclosure are described by using specific embodiments herein. The description of the above embodiments is only used to help understand the method and core idea of the present disclosure. In addition, for those skilled in the art, according to the idea of the present disclosure, there will be changes in the specific implementation and application scope. In conclusion, the contents of this specification should not be understood as limiting the present disclosure.

What is claimed is:

1. A polyimide, wherein a main chain of the polyimide comprises at least one graft group, and the graft group is bonded with a first side-chain group represented by a formula (1) and a second side-chain group represented by a formula (2); 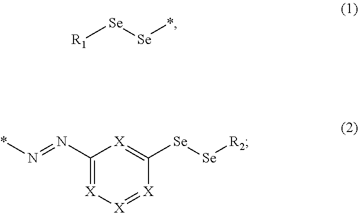
wherein R₁ and R₂ are independently selected from the group consisting of an alkyl group, an aryl group, and a heteroaryl group, X is at each occurrence independently selected from N or a CY group, Y is selected from hydrogen or an alkyl group, and * represents a substitution site; and
the graft group is selected from a phenyl group or a heterophenyl group, and the first side-chain group and the second side-chain group are bonded to the graft group in a meta-substitution manner.

2. The polyimide according to claim 1, wherein the polyimide comprises a plurality of first repeating units and a plurality of second repeating units, and the plurality of second repeating units have the graft group.

3. The polyimide according to claim 2, wherein a structure of each of the first repeating units is represented by a formula (3), and a structure of each of the second repeating units is represented by a formula (4) as follows: 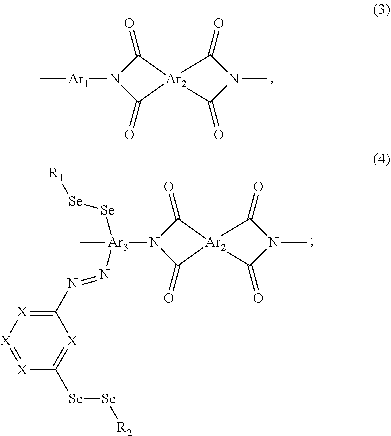
wherein Ar₁ to Ar₃ are independently selected from an aryl and a heteroaryl group having 6 to 30 ring atoms, Ar₃ has the graft group.

4. The polyimide according to claim 3, wherein a structure of the polyimide is represented by a formula (5) as follows: 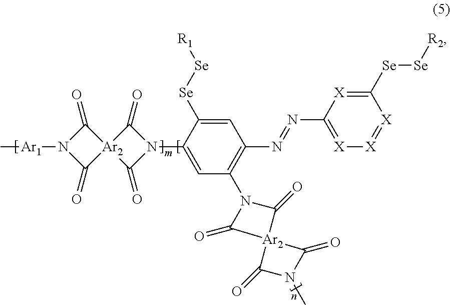
wherein m and n are independently selected from positive integers.

5. The polyimide according to claim 1, wherein R₁ and R₂ are independently selected from the group consisting of a methyl group, an ethyl group, a propyl group, a butyl group, a pentyl group, a hexyl group, a phenyl group, a biphenyl group, a naphthyl group, and a pyridyl group.

6. The polyimide according to claim 1, wherein a structure of the second side-chain group is shown in a formula as follows: 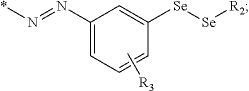
where R₃ is selected from a linear alkyl group or a branched alkyl group.

7. The polyimide according to claim 3, wherein Ar₁ is selected from the group consisting of: 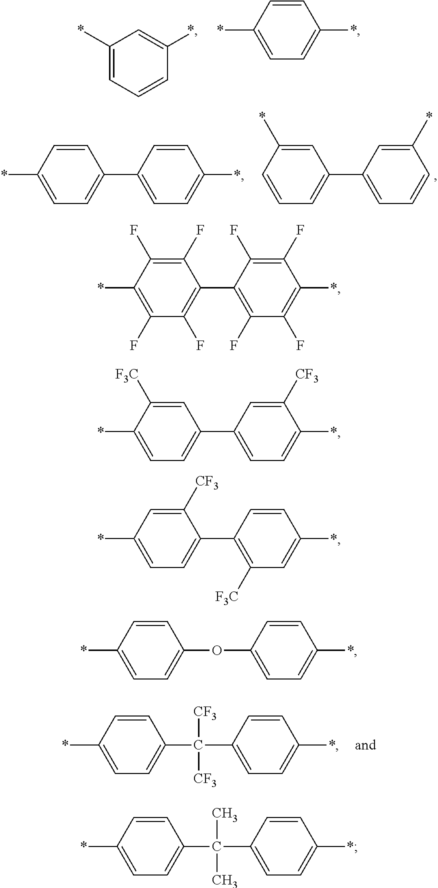
and/or
Ar₂ is selected from the group consisting of:

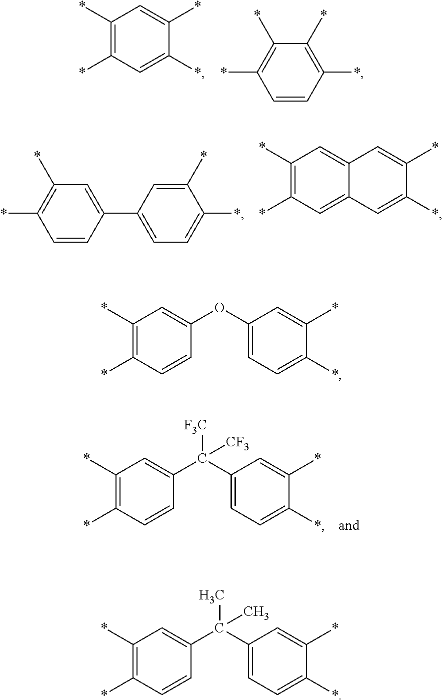

8. The polyimide according to claim 2, wherein a ratio of a number of the plurality of second repeating units to a total number of the plurality of first repeating units and the plurality of second repeating units is less than or equal to 30%.

9. The polyimide according to claim 1, wherein a relative molecular mass of the polyimide is in a range of 1,000-10,000.

10. A display panel, comprising a first substrate and a second substrate disposed opposite to each other, and a liquid crystal layer sandwiched between the first substrate and the second substrate; wherein at least one of a side of the first substrate close to the liquid crystal layer and a side of the second substrate close to the liquid crystal layer is provided with an alignment layer, and the alignment layer is made of a polyimide,
wherein a main chain of the polyimide comprises at least one graft group, and the graft group is bonded with a first side-chain group represented by a formula (1) and a second side-chain group represented by a formula (2); 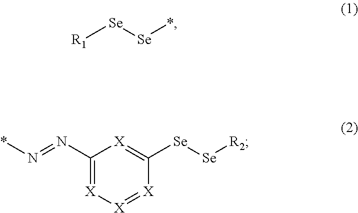
R₁ and R₂ are independently selected from the group consisting of an alkyl group, an aryl group, and a heteroaryl group, X is at each occurrence independently selected from N or a CY group, Y is selected from hydrogen or an alkyl group, and * represents a substitution site; and
the graft group is selected from a phenyl group or a heterophenyl group, and the first side-chain group and the second side-chain group are bonded to the graft group in a meta-substitution manner.

11. The display panel according to claim 10, wherein the polyimide comprises a plurality of first repeating units and a plurality of second repeating units, and the plurality of second repeating units have the graft group.

12. The display panel according to claim 11, wherein a structure of each of the first repeating units is represented by a formula (3) and a structure of each of the second repeating units is represented by a formula (4) as follows: 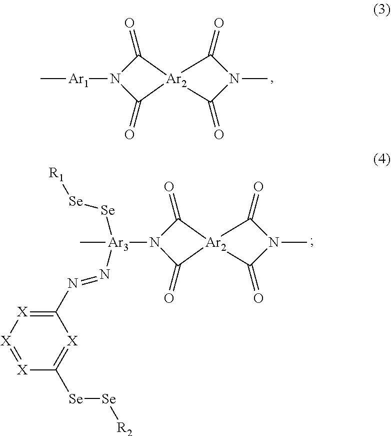
wherein Ar₁ to Ar₃ are independently selected from an aryl and a heteroaryl group having 6 to 30 ring atoms, Ar₃ has the graft group.

13. The display panel according to claim 12, wherein a structure of the polyimide is represented by a formula (5) as follows: 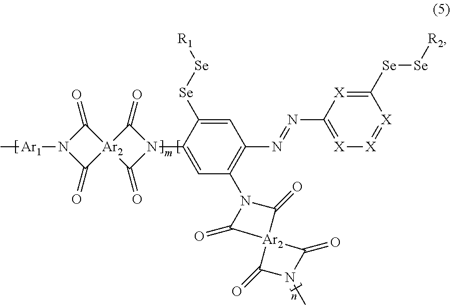
wherein m and n are independently selected from positive integers.

14. The display panel according to claim 10, wherein R₁ and R₂ are independently selected from the group consisting of a methyl group, an ethyl group, a propyl group, a butyl group, a pentyl group, a hexyl group, a phenyl group, a biphenyl group, a naphthyl group, and a pyridyl group.

15. The display panel according to claim 10, wherein a structure of the second side-chain group is shown in a formula as follows: 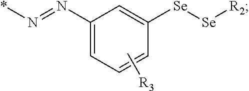
where R₃ is selected from a linear alkyl group or a branched alkyl group.

16. The display panel according to claim 12, wherein Ar₁ is selected from the group consisting of: 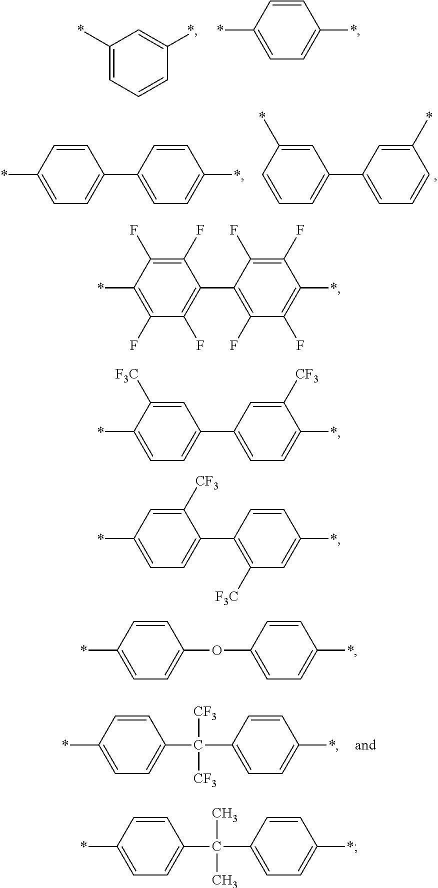
and/or
Ar₂ is selected from the group consisting of:

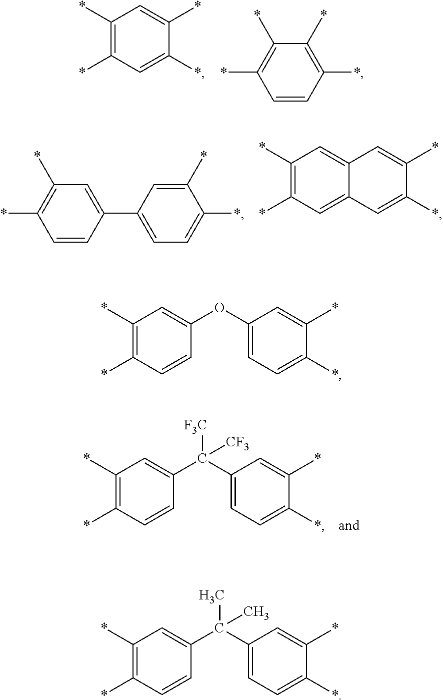

17. The display panel according to claim 11, wherein a ratio of a number of the plurality of second repeating units to a total number of the plurality of first repeating units and the plurality of second repeating units is less than or equal to 30%.

18. The display panel according to claim 10, wherein a relative molecular mass of the polyimide is in a range of 1,000-10,000.
